(19) United States
(12) Patent Application Publication
(10) Pub. No.: US 2007/0016933 A1
(43) Pub. Date: Jan. 18, 2007

(54) RF signal injector

(76) Inventors: Steven M. Wollmershauser, San Antonio, TX (US); Brian Wilson, San Antonio, TX (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/181,562

(22) Filed: Jul. 13, 2005

(51) Int. Cl. H04N 7/16; H04N 7/173; H04N 7/18

(52) U.S. Cl. 725/81; 725/100; 725/133; 725/141; 725/153

(57) ABSTRACT

A content delivery system is described that includes a processing unit and a remote device. A signal injector located in proximity to the remote device is coupled to the processing unit via a wired connection. The signal injector collects and filters RF signals from a remote control device and communicates the filtered RF signal to the processing unit over the wired connection.

### FIELD OF THE INVENTION

This disclosure relates generally to the field of electronic remote controls and methods, including providing RF signal injection for remote communication.

### BACKGROUND OF THE INVENTION

Electronic remote controls are well known for controlling devices from a remote distance. The remote control can communicate command signals in a variety of ways, including radio frequency (RF) signals or infrared (IR) signals. IR signals require a line of sight between the controller and the device being controlled. RF controllers can control devices within a physical range of the controller. As such, devices having an obstructed line of sight between the controller and the device can be controlled with the RF controller.

External factors, such as building walls and furniture, can influence the performance of RF controllers. For example, accurately controlling a set-top television processor from a separate room in a house may be prohibited because the location of a refrigerator in between the remote control and the set top box.

### BRIEF DESCRIPTION OF THE DRAWINGS

Embodiments of the invention are illustrated by way of example and not limitation in the figures of the accompanying drawings, in which like references indicate similar elements and in which:

FIG. 1 is a block diagram of a system according to one embodiment of the present invention;

FIG. 2 is a prior art device adapted to inject RF signals on a coaxial cable;

FIG. 3 is a block diagram of an RF signal injector according to embodiments of the present invention; and

FIG. 4 is a flow chart of methods according to embodiments of the present invention.

### DETAILED DESCRIPTION

In the following descriptions, for purposes of explanation, numerous specific details are set forth in order to provide a thorough understanding of the various embodiments. It will be evident, however, to one skilled in the art that embodiments of the invention may be practiced without making use of many of these specific details.

FIG. 1 is a diagram of a system 100 according to one embodiment of the present invention. The system includes a processing unit 110 for receiving and controlling content. For example, the processing unit can be a television processing unit for receiving audio/video content from a receiving device such as a satellite dish 112. It will be appreciated by those skilled in the art that the processing unit is not limited to a specific type of content material or a manner in which the content material is communicated to the processor unit. As such, audio, visual, or interactive material can be processed from wired (cable) or wireless communications.

The processing unit is coupled to a remote device 114. The remote device can be any device receiving signals from the processing unit. In one embodiment, the remote device 114 is a visual monitor such as a television. The processing unit is coupled to the remote device via wired connections 140 and 150, such as a two conductor cable. In one embodiment the wired connection is a shielded cable, such as a coaxial cable.

A remote control 116 provides control signals to the processing unit, for example control signals to select a television station, content or interactive commands. The remote control transmits the command signals using radio frequencies (RF). In one embodiment, the RF signals are in an ultra-high frequency (UHF) range of 432 to 435 MHz. The present invention, however, is not limited to a specific frequency range.

A signal injector 120 is located in proximity to the remote device. As illustrated the processor 110 is located in room 102 of a house while the remote device 114 is located in room 104. The signal injector is coupled to the processing unit via the wired connection 140. As explained below, the signal injector collects the RF signal from the remote control 116 and communicates the RF signal to the processing unit over the wired connection. As such, signal interference between the remote control and the processing unit can be overcome. In addition to monitoring wireless communication commands from the remote control 116, the processor unit monitors the wired connection 140 for control signals injected thereon by signal injector 120.

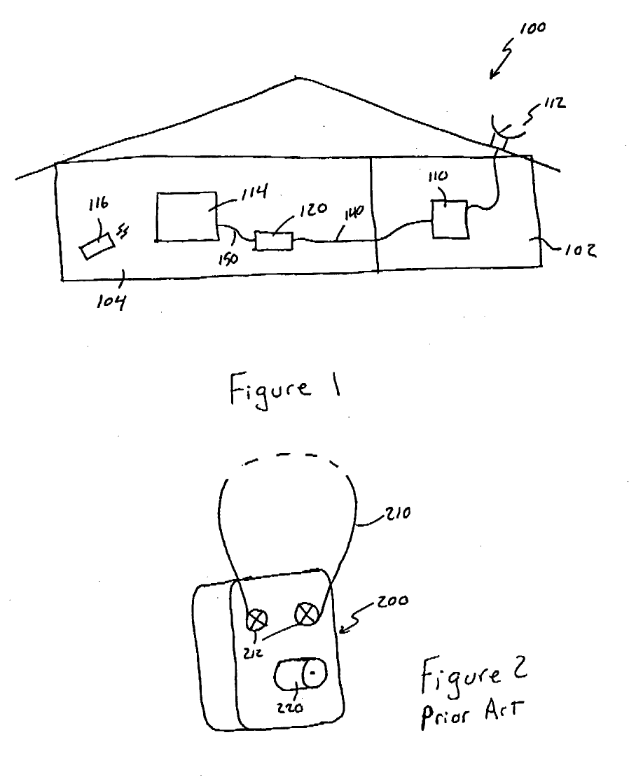

Prior to describing the signal injector, a prior art device adapted to be used for signal injection is described with reference to FIG. 2. The device is a modified UHF adaptor 200. The adaptor includes a female connection 220 and mechanical screw connections 212. The screw connections are coupled to the female connection with conductors (not shown) located within the adaptor. The adaptor does not contain signal processing or modification components. To function as a signal injector, a wire loop antenna 210 is coupled to the screw connections. The antenna can be “tuned” to a frequency by selecting a length of the wire to be approximately equal to one wavelength of a desired RF signal. The female connection is coupled, in operation, to a coaxial cable connected to a processing unit. The prior art device does not include signal processing or shielding and can inject a wide range of RF signals.

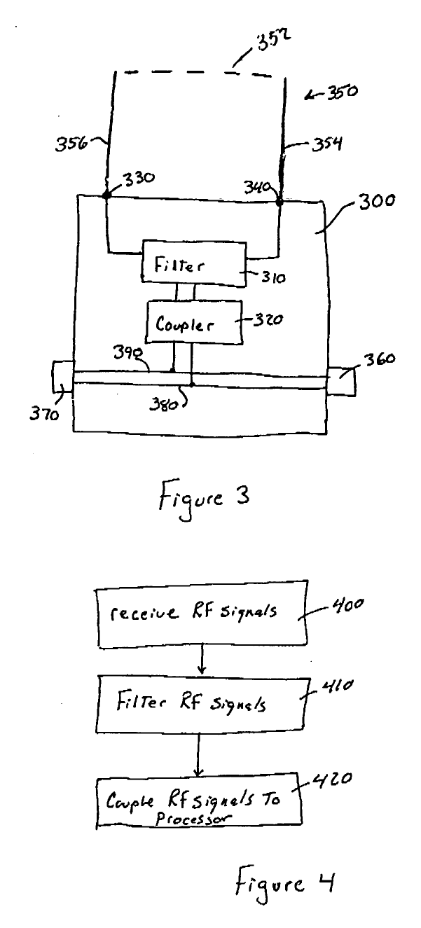

Referring to FIG. 3 a block diagram of an RF signal injector 300 according to embodiments of the invention is described. The signal injector includes an input connection 360 and an output connection 370 coupled together with conductors 380 and 390. In one embodiment, the input and output connections are threaded male 75 ohm connectors sized to mate with a female coaxial cable connection. The injector includes antenna connections 330 and 340 for coupling to a wire antenna 350. The antenna connections are coupled to a band pass, or notch filter 310. The band pass filter is coupled to the input and output connections through a directional coupler 320. Optionally, the band pass filter can be directly coupled to the input and output connections using a conductive splitter (not shown).

In one embodiment, the wire antenna is sized to a specific frequency. That is, the length of the antenna wire is selected to match a desired frequency wavelength to optimize the signal at a particular frequency. In an embodiment where the remote control 116 transmits in the 432 to 435 MHz range, the antenna can be sized to match a wavelength of about 433 MHz.

The band pass filter 310 rejects RF signals outside of a desired frequency range. In one embodiment, the band pass filter has a pass range of 432 to 435 MHz. RF signals outside of this range, therefore, are rejected or reduced depending on the signal strength.

The optional directional coupler 320 is provided to manage signal loss between the input, output and antenna connections. That is, the coupler provides a larger signal decibel reduction between the antenna connections and the output connection, than the signal decibel loss between the antenna connections and the input connection. For example, in one embodiment the out-of-band rejection between the antenna connections and the output connection can achieve up to −65 dB (including the band pass filter), and the out-of-band rejection between the antenna connections and the input connection can achieve up to −45 dB.

In operation, the remote control 116 transmits an RF signal containing control command signals intended for the processing unit 110. The RF signal is received by antenna 350 and processed by the band pass filter 310. RF signals within the pass band of the filter are coupled to the input connection to be received by the processing unit. In one embodiment, the received RF signals pass through the directional coupler 320 to further filter undesired RF signals from being injected to the wired connection 140 coupled to input 360. The optional directional coupler also reduces off-air in-band interference through the remote device 114, coupled to the injector output 370 with wired connection 150, if a high off-air RF signal interference is experienced on the remote device and any other signal operating frequency. If high off-air RF signals make it through the device filtering they will be dissipated by the wire length and other passive components coupled to the wired connection.

Referring to FIG. 4 a flow chart of methods according to embodiments of the present invention are described. The method includes, at 400 receiving radio frequency (RF) signals using an antenna. The RF signals are filtered at 410 to reject components of the RF signals having a frequency outside of a predetermined frequency window. At 420 the filtered RF signals are coupled to a conductor to provide control commands to a processing unit coupled to the conductor.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A radio frequency signal injector comprising:
input connection conductively coupled to an output connection via a conductor;
an antenna connection; and
a band pass filter coupled between the antenna connection and the conductor to couple radio frequency signals received on the antenna connection having a frequency between upper and lower frequency limits to the input connection.

2. The radio frequency signal injector of claim 1 further comprising an antenna connected to the antenna connection, wherein the antenna is tuned to a frequency that matches the Remote control center frequency.

3. The radio frequency signal injector of claim 1 wherein the input and output connections are sized to interface with female coaxial cable connectors.

4. The radio frequency signal injector of claim 1 further comprising a directional coupler connected between the band pass filter and the conductor, wherein the directional coupler reduces a level of the radio frequency signals coupled to the output connection relative to a level of the radio frequency signals coupled to the input connection.

5. The radio frequency signal injector of claim 1 wherein the upper and lower frequency limits are 435 and 432 Mhz, respectively.

6. A radio frequency signal injector comprising:
an input connection to provide an interface to a processing unit conductor;
an output connection to provide an interface to a remote device conductor, wherein the input and output connections are connected together an internal conductor;
an antenna connection to connect to an antenna;
a directional coupler connected to the internal conductor; and
a band pass filter coupled between the antenna connection and the directional coupler to couple radio frequency signals received on the antenna connection having a frequency between upper and lower frequency limits to the internal connector.

7. The radio frequency signal injector of claim 6 wherein the upper and lower frequency limits are 435 and 432 Mhz, respectively.

8. The radio frequency signal injector of claim 7 wherein the antenna is tuned to a center frequency of 433 MHz.

9. The radio frequency signal injector of claim 6 wherein the input and output connections are threaded male connections sized to interface with threaded female coaxial cable connectors.

10. A system comprising:
a processing unit;
a remote device; and
a radio frequency signal injector comprising,
an input connection coupled to the processing unit via a multi-conductor input cable,
an output connection coupled to the remote unit via a multi-conductor output cable, the input and output connections are electrically connected via internal conductors, wherein signals transmitted by the processing unit are coupled to the remote unit via the input cable, internal conductors and output cable;
an antenna connection to receive radio frequency signals, and
a band pass filter coupled between the antenna connection and the internal conductors to couple the radio frequency signals having a frequency between upper and lower frequency limits to the internal conductors.

11. The system of claim 10 wherein the upper and lower frequency limits are 435 and 432 Mhz, respectively.

12. The system of claim 11 wherein the antenna is a wire loop having a length tuned to a 433 MHz frequency.

13. The system of claim 10 wherein the input and output cables are shielded coaxial cables.

14. A method comprising:
receiving radio frequency (RF) signals using an antenna;
filtering the RF signals to reject components of the RF signals having a frequency outside of a predetermined frequency window; and
coupling the filtered RF signals to a conductor to provide control commands to a processing unit coupled to the conductor.

15. The method of claim 14 wherein the radio frequency (RF) signals comprise the control commands.

16. The method of claim 14 wherein the predetermined frequency window is between about 432 and 435 MHz.

17. The method of claim 16 wherein the antenna is tuned to a frequency of about 433 MHz.

18. The method of claim 14 wherein coupling the filtered RF signals to the conductor comprises directionally coupling the filtered RF signals to the conductor to provide a greater signal loss in one direction of the conductor.
